(19) United States
(12) Patent Application Publication
(10) Pub. No.: US 2012/0084604 A1
(43) Pub. Date: Apr. 5, 2012

(54) Automation system for testing and measurement of system and device parameters, and control and automation of systems

(76) Inventor: Frank Tamilio, Chelmsford, MA (US)

(21) Appl. No.: 12/924,616

(22) Filed: Oct. 1, 2010

(51) Int. Cl. G06F 1/26; G06F 13/14; G06F 11/263

(52) U.S. Cl. 714/32; 713/300; 710/305; 714/E11.177

(57) ABSTRACT

A system and apparatus which allows for superior testing and measurement, as well as control and automation capabilities. This invention comprises a modular foundational system for automation that provides essential building blocks for a variety of test, measurement and internal/external control demands. The essentials include IEEE-488 communications capability which matches the caliber of large test stand, thus providing a configurable system that possesses great capabilities in test, measurement and automation, without prohibitive cost and complexities for the user. The platform described herein is also well suited for portable applications as the system does not occupy a significant amount of space.

### BACKGROUND OF THE INVENTION

1. Field of the Invention

The instant invention relates generally to traditional automation systems as well as intermediate automation applications that are more often of a portable nature. The invention further more specifically relates to testing and measurement systems and devices, as well as control and automation systems.

2. Description of the Related Art

State of the art data acquisition systems consist of sometimes large, cumbersome systems, comprised of mainframes that generally house large plug in PC boards or modules in order to connect to a predefined bus such as PCI, PXI or VXI standards. The mainframe includes the power source connections as well as both input and output signal distribution. These standards also define the electrical as well as mechanical forms which limit system expandability. The number of modules is limited by the number of slots in the mainframe. Typically such a system is destined to focus on certain high volume applications in a particular field of endeavor. However, this type of automated power is often beyond the reach of smaller and more portable work station scenarios.

In addition, flexibility is not inherent in concurrent designs as many are only targeting a limited number of applications and thus the present systems are not as adaptable and reusable. Also today's state of the art systems have considerable complexities involved in the configuration process. This often makes it necessary to embark on a significant development effort in order to implement them into their particular targeted field of work. This invention partners hardware with Graphical User Interface software to optimize flexibility enhance functionality and reduce user complexities. This invention proposes a system where more modules are available because the system is not confined to a fixed number of slots as in the traditional mainframe configurations.

### SUMMARY OF THE INVENTION

The present invention, as illustrated herein, is clearly not anticipated, rendered obvious, or entertained in any of the prior art mechanisms, either alone or in any combination thereof.

The general purpose of the present invention, which will be described subsequently in greater detail, is to provide an automation system for testing and measurement of systems and devices parameters, as well as control and automation of systems. The present system spawns from the observation that the three most essential factors involved in a comprehensive computer automated system are arguably the ability to collect and measure data from diverse types of sensors and transducers, the ability to use software to control the electrical status of external equipment and the ability to communicate effectively with sophisticated instrumentation and control the various programmable attributes therein. Thus, in view of the greater need for such features as modularity, an efficient automated system, fully expandable for many types of automation demands, is herein disclosed.

Thus the present system encompasses an expandable system that offers automated test and data logging capability in addition to power and instrumentation control; enhanced by remote control. Additionally, interest in recyclable, more compact systems exemplifying greater flexibility and adaptability to a variety applications, such as the present system, is peaking. The genre of system proposed herein leverages the advantages of smaller hardware, the usability of smaller equipment and the expandable configurability of innovative hardware design, complimented by software.

Herein is illustrated, a more cost effective manner of utilizing automated advantages for those applications not previously seen as deserving such attention. Also demonstrated is an additional tier or two of automated power, mainly due to the well focused design and configurable nature of the implementation. This platform intends to convey that the transitions of technology are such that effective automated power is not necessarily diminished by decreased system size, and intends to take full advantage of technological advances by implementing sophisticated software design to leverage the advantages.

Further, the infusion of software controls into the system manages parameters to increase the system capabilities and improve system flexibility. The additional capabilities that the partnership of software lends to these three factors alone are somewhat unexpected and highly favorable. For example since software defines the flow of the operation, much of the functionality though complex can be focused to give the user intriguing range of real time equipment control. System control, over IP via Ethernet and RF essentially creates a remote controlled test lab conducive for many types of test, measurement and control scenarios.

The purpose of the disclosed system is to render automated test, measurement and control more pragmatic and feasible for a greater number of applications, while concurrently providing a highly flexible foundation for expandability. Modern developments within the art have lent to a distinctly modular and expansion friendly technology known as Universal Serial Bus (USB), which comprises a specification to establish communication between devices and a host controller (typically personal computers). USB is intended to replace serial and parallel computer ports in favor of USB. USB was designed to connect consumer peripherals such as mice, keyboards, digital cameras, printers, personal media players, flash drives, and external hard drives to a computer.

USB has provided considerable qualities that prior, less capable technologies lacked. Thus, these qualities are implemented in the present system. Utilizing USB communications, system size can be reduced as modules no longer require complex and substantial mechanical connectivity requirements as in previous technologies. Additionally, because the form factors of USB modules are not regulated by mainframe bus connectivity, they need only a cable for connectivity to a USB hub. In this manner, USB is also very convenient to configure electrically as any number of modules can be connected to the same hub, yet be effectively addressed individually or otherwise by the user software.

With these advantages it becomes possible to significantly reduce the physical size of similar equipment and yet harness the important qualities of a larger system. The present system arises from the observation that the three most essential factors required in a comprehensive computer automated system are: the ability to collect and measure data from diverse types of sensors and transducers; the ability to use software to programmatically control and monitor the electrical status of external equipment and the ability to communicate effectively with sophisticated instrumentation.

Thus, herein revealed is an efficient and flexible automated system that can be clearly expanded for many types of automation demands. The marriage of software control and enhancements quite effectively increases the systems capabilities and improves flexibility. The additional capabilities that arise from these essential factors alone are somewhat unanticipated. For example software makes possible, real time control in a servo loop. In addition the system's own environmental conditions and health can be queried on demand. Much of the functionality utilizes the software to shield the user from typical complexities and, at the same time, provides a broad range of system and equipment control.

Thus, one purpose of this invention is to propose a system that requires little more than software upgrades to facilitate numerous expandable capabilities. Since the internal modules do not have the innately large form factors that a typical mainframe system would have, a considerable collection of module equipment can be contained, and additional expansion can be enabled by software.

Another important element or factor in automation is the hardware user interface. This evolution generally involves connecting the units under test to the system via hardware connectors. In addition certain hardware is also typical, such as that required to provide more convenient connectivity to devices. Included is other electrical porting to optimize test efficiency. In addition, other customization is required in order to closely align the demands of a particular application. Some examples wherein the differences typically occur are situations where the quantity of units in one application, differ from those of another or where some units require connectivity via a single connector while others require multiple connectors per unit under test; just to name a few examples.

The inherent flexibility of the present platform simplifies this area of the demand as the nature of the architecture of the present system is such that much of the hardware typically required here is available as part of the array of system modules, therefore the need for external hardware is diminished. Nevertheless the capability exists within the present platform to utilize detachable hardware interfaces where external interfaces may not be preferred by some users.

Another purpose of the present system focuses on size issues inherent with concurrent systems that have comparable capabilities. The system herein proposes a generally feasible automated system for non fixed applications. An inherent benefit of the fact that the modules introduced herein are not designed for a standard mainframe, the system possesses a smaller form and yet comprises an immense level of automation power. Thus, the system renders automation and control available to portable applications, particularly those with limited space and those also which were traditionally not exposed to computer automation.

Another advantage of the present system relates to leveraging the software to reduce the complexities normally associated with operating non-computer controlled instrumentation. Through the use of Graphical User Interface (GUI) software, all of the functions associated with an instrument that traditionally required manually searching in menus are targeted and necessarily exposed by the user interface. Thus, utilization of (GUI) software renders the present system a very useful tool for operating equipment more smoothly and interactively. The GUI can be designed in such a manner as to arrange and reveal the required buttons and controls from inside soft key menus then label them in a manner that is more straightforward for the user to navigate and manage. Therefore, the present invention will inherently allow less skilled talent to perform a much greater level of work, hence enhancing efficiency and user training cycle.

The present platform thus illustrates a self contained system combining Test, Measurement and Automation power with versatility. It accomplishes this because it contains both the ability to communicate with quantities of complex instrumentation (of which the design engineer is already familiar) therefore potentially enabling convenient adaptation to the users current test environment. This invention is comprised of a collection of complimentary hardware that yields itself quite configurable to an array of important customizable demands. The concept is designed around the premise that the correct collection of equipment partnered with effective software makes for a powerful and extremely configurable apparatus. Therefore, the intention of the present design is to prevent the need for system hardware redesign for each application, but instead procure a situation where configurability rests in large part on accommodating software.

The hardware of the present platform is designed to take into account an array of scenarios and is configured to be as broad or narrow in focus as needed. A network of interchangeable cables, flash firmware, software controlled switching networks and detachable interface hardware offers effective intermediate configurability. The effort is largely complimented by the user software that is designed to assist the user to navigate the complexities of both the equipment and the attached instrumentation.

The system herein strikes a balance between comprehensive system hardware and software platform designed to dramatically reduce the need for lengthy engineering customization and software selectable applications. A detachable user interface provides another layer of flexibility and lessens the engineering design demands in addition to minimizing system size and rendering the system more adaptable to applications where space is limited. Another area where the present system brings to the forefront automation power and versatility is in the computer controlled instrumentation BUS, IEEE-488 which enables effective system to computer communications for controlling reputable sophisticated instrumentation.

Thus, the current platform not only matches the abilities of large dedicated systems, but also solidifies the present system's capability to handle and manage complex work product. This BUS, IEEE-488 (“IEEE-488”) protocol makes it possible for the invention to respond to applications wherein multiple instrumentation components may be automated in parallel with other system functions. IEEE-488 has long been the de facto standard for instrumentation control and communications. Due to the advancements herein, the present system is poised to be a favored platform for portable automated demands, as the system is comprised of a vast amount of test and measurement power while providing the functionality of many larger systems that fail to exhibit adaptability to size constraints and other limiting factors.

In addition, the basic form of the instant system derives these capabilities from utilization of a single USB port of an ordinary computer system, therefore eliminating the intrusive requirements of proprietary computer modules in order to be compatible with this automation system. Rather the system is designed as standalone platform that will work with the users own current computer system and instrumentation equipment.

While the present system finds original basis in fields surrounding test and measurement, and demands that grow more complex therein, this flexible design renders the system quite capable of operation with the fields of various analog and digital signal generation and control as well. Thus, the current design inherently offers the ability to control power to a large assortment of equipment simultaneously, on demand as needed, to reconfigure properties of the test stimulus and the actual system configuration, and to perform remote exploratory testing and ancillary functions along those lines. The inherent strengths herein illustrated with regard to control are useful for configuring both the internal functions of the system and real world automated applications because switch signals need only software to enable them to perform specific tasks at specific times are provided. This configuration can be quite useful in both sense/detect in addition to control scenarios.

Ergo, the strengths in the above mentioned areas essentially create an additional important tier of automated power. For example: providing automatic, remote turn on/off and variable functions of external equipment as well as the system itself, due to detection of an extreme condition. The functional attributes described here take on a whole new dimension when combined with Ethernet and wireless access, to control the system as well as run queries throughout the system for data. Both the actual system vitals and the test data become accessible via many methods including Ethernet and wireless access. Additionally these gateways allow the operator full access to its functions and creates a fully remote real time control, test, measurement and control lab, complete with data recording and reporting. Which, when accompanied by effective software creates a very versatile automated test and control system.

There has thus been outlined, rather broadly, the more important features of the automation system for testing and measurement of systems and devices parameters, as well as control and automation of system in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in it's application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIG. 1 is a block diagram illustrating the System Interconnect Diagram and hardware configuration;

FIG. 2 is a descriptive diagram illustrating the Measurement Configurations;

FIG. 3 is a block diagram illustrating the control configurations for the D I/O and D/A configurations;

FIG. 4 is a block circuit diagram illustrating the user hardware interface configurations;

FIG. 5 is a block diagram illustrating the basic system configuration;

FIG. 6 is a block diagram illustrating the stand alone configuration; and,

FIG. 7 is a block diagram illustrating remote control configurations via various means including Ethernet and Wifi.

### DETAILED DESCRIPTION OF THE PREFERRED EMBODIMENTS

The detailed description set forth below in connection with the appended drawings is intended as a description of presently-preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention, such as tremolos used in a variety of applications.

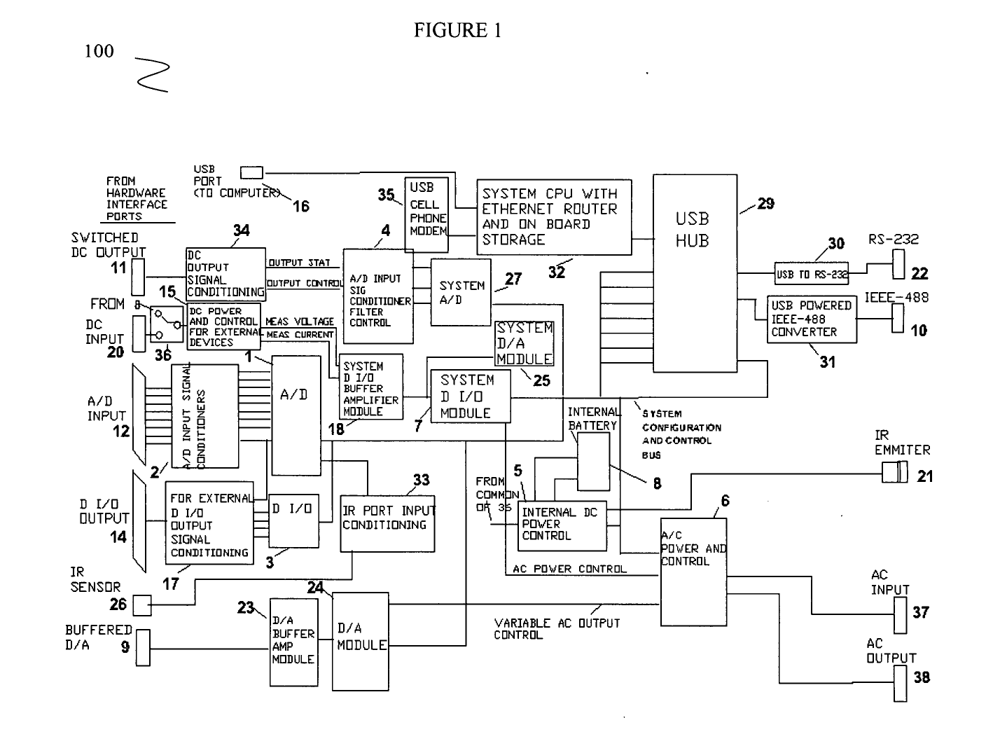

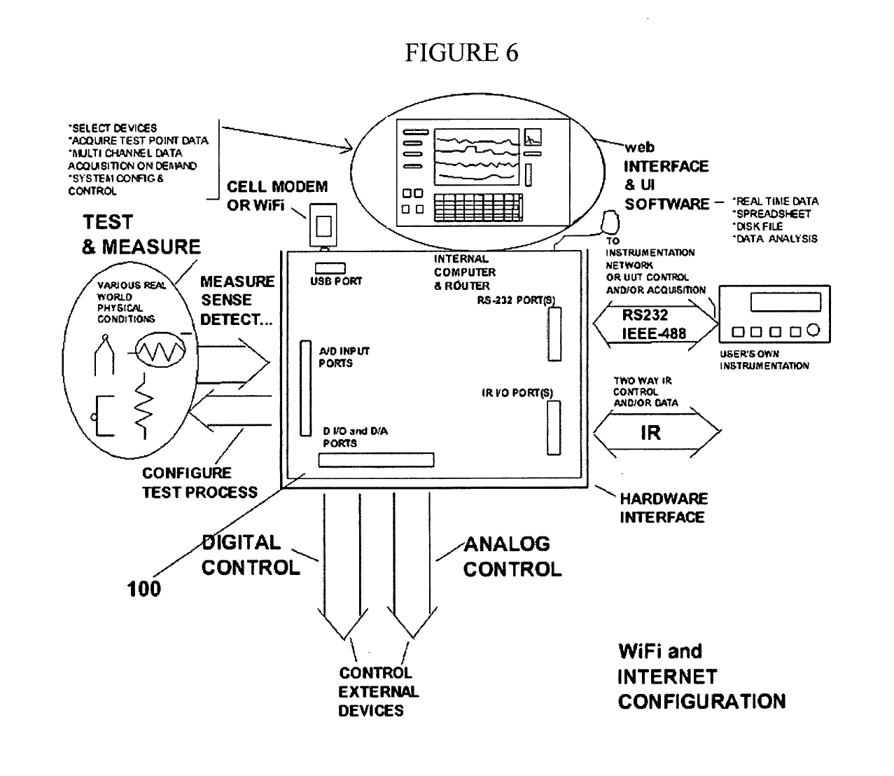

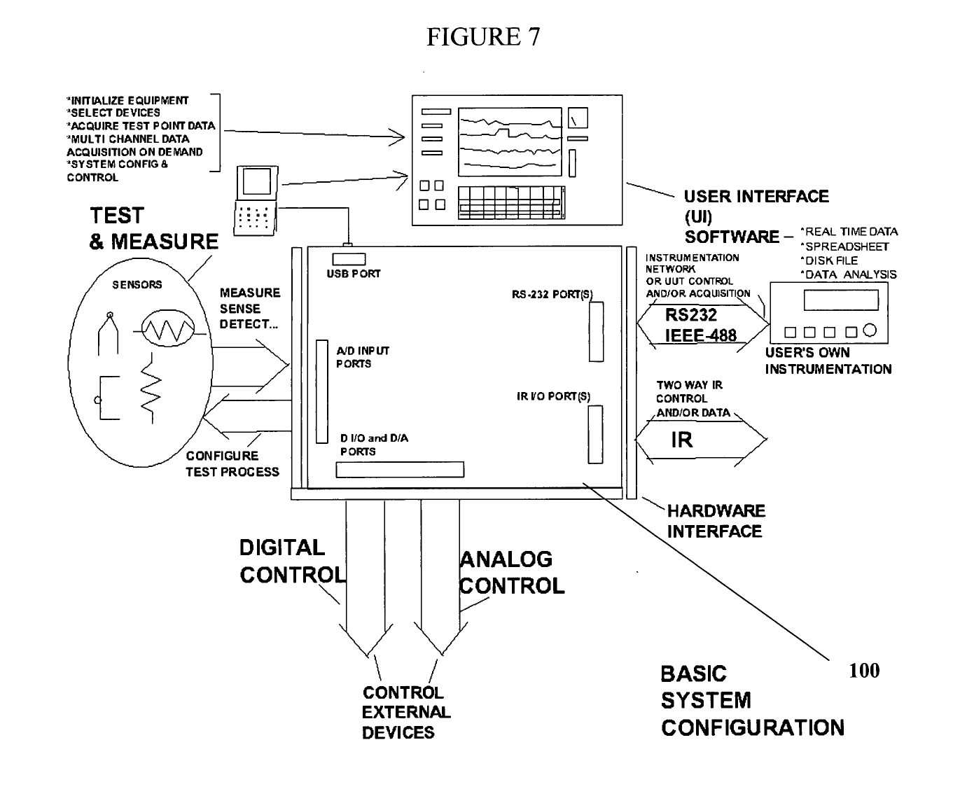

Referring now to the figures to better illustrate the present invention, in FIGS. 1-7, as is illustrated herein, the instant invention derives a great deal of flexibility and capability from utilization of the very advantageous Universal Serial Interface Bus (USB). One of the important benefits USB offers is the capability to control numerous programmable devices from a single computer port via a USB hub. The programmable devices used here are deployed for both external device testing and control as well as in the actual system architecture; to administer remote system querying and reporting. The functions are mainly for acquiring and detecting measurement data, configuring many forms of testing and for the automation and control aspects. A large quantity of programmable devices can be electrically grouped yet be completely distinguishable from each other by the computer software. This is extremely beneficial and it is a favorable alternative to the older convention known as the standard/traditional mainframe buses. This former technology required significantly more real-estate to produce similar results where a quantity of programmable sub systems (large PC boards with physically large connectors) could be electrically paralleled and then programmatically and individually addressed by the computer software. The USB bus does this in a more compressed fashion both electrically and physically. This helps streamline the subsystem hardware interconnectivity without complicating the computer connectivity.

The USB bus not only utilizes computer power, it inherently diminishes the “real-estate” normally required to tap this power, thus revealing the previously untapped inner workings of computer power to much of the outside world. In essence this system capitalizes on the advantages of USB implementation in order to address the functions of the individual modules, as well as to harness maximum control over system functions via software control mechanisms. Additionally, the USB bus, via utilization of the system modules, provides expandable functionality.

One problem encountered in common automated systems centers around the need for interfacing circuitry. This is often extensive and necessary in order to prepare the system for an application that involves real units to test, measure and/or control. This in many ways is due to the lack of space in typical mainframe systems where plug-in circuit card modules occupy most of the available space on the connector plane; therefore application specific circuitry is often external. The system described herein provides for more in system module diversity, therefore much of the required interfacing is merely with regard to connectivity customization and less with internal capability limitations. Conveniently, the USB bus is perfect for modularity and can double as a power source in certain configurations. Since USB modules require significantly less power than many mainframe plug-ins, operation on battery power is also possible. This advantage paves the way for completely self contained and unattended operation as well.

Thus, as such a vast quantity of capability and control is available via the USB bus, the present system utilizes the inherent expandability of the USB bus. Additional, duplicative or supplementary modules (off the shelf or otherwise) may be conveniently added to the bus. One area wherein this system leverages non-off the shelf power is using the USB bus to convert to other communications protocols to manage the system architecture and in turn enhance configurability. Internally the system converts the USB bus to spread out embedded software technologies to induce maximum configurability of the system itself. USB is used to convert computer power from higher level control to embedded system control and configurability via I²C and SPI microcontroller protocols. Having this level of flexibility it is not only useful to configure the system but it maximizes the flexibility for an array of additional functionality.

The modules themselves offer a significant capability that is multiplied by mixing with the correct user software. The hardware interface is such that the user can interface with all of the module functions programmatically, right on the user interface panel, thus allotting the user the capability of operating the functions that need to be employed and disabling, or not connecting those that are not required. The graphical user interface (GUI) software is used to provide the user access to predefined controls and functions and at the same time shield the user from the “under the hood” software complexities. The GUI form of software is favorable to facilitate user ease in translation of specific tasks and operational transparency. One critical function of the software is to provide routines that will map specific user controls and displays to designer predefined functions and capabilities. Thus, the present system in effect converts manually complex tasks to a series of descriptive and selectable controls on the user interface.

As seen herein, FIG. 1 is a block diagram illustrating the System Interconnect Diagram 100 and hardware configuration which illustrates the elements of the system.

### The Modules

Addressing the individual modules:

### Analog to Digital (A/D) Modules

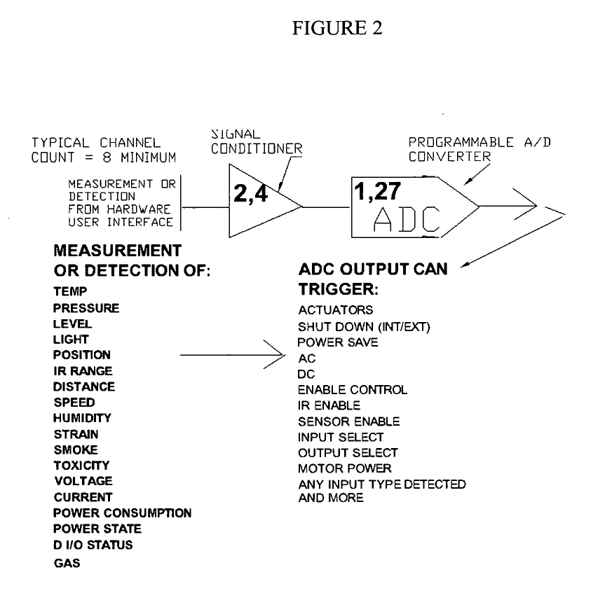

These Analog to Digital (A/D) modules 1, 27, as best illustrated in FIGS. 1, 2 are the heart of the external and internal measurement and detect capability in the system hence accomplish useful functions centered around sensing a voltage, waveform and any real world physical conditions via sensors or transducers which convert the physics into electrical signals that enter the A/D module 1 through the signal conditioner module 2 and then allow processing values by a computer. Herein illustrated, the ability of the system to detect performance of a device(s), detect changes in conditions and status, then record and report the data. This signal data may be converted into many forms that may be monitored, recorded on spreadsheets, and reported from remote locations. This signal data may also be used as signaling to trigger other functions in the system, including, but not limited to, measuring temperature, pressure, level, and sensing power shut down.

State of the art software is designed to process this genre of data and thus, is able to control many, or all, of the functions of the A/D modules 1 that characterize a particular type of measurement. The data can be collected and then analyzed later or monitored live and processed immediately by engineers and researchers. This invention utilizes modules that may possess between 8 and 16 channels of measurement power (see FIG. 2). Banks of these devices can be monitored simultaneously, or processed and then analyzed by computer software later or concurrently afford this invaluable capability to the many other applications that the present system accomplishes; related to test and measurement.

Thus far, the measurement capability of the present design has been discussed. However the power these A/D modules 1,27 implementation cannot be fully appreciated until the A/D modules are fully deployed as an important component of the internal system's architecture and it's ability to be programmatically manipulated, monitored and queried. A/D module 1, adds useful functions for external connectivity via input signal conditioning 2. A/D modules 27 are added to the architecture of the internal system and deployed as a resource to make internal measurements and other functions such as dedicated system status detection/monitoring and power management, etc. A/D module 27 is especially useful for a large assortment of functions, as it is fully controlled and data processed by the computer, and in partnership with software, has considerable hidden value and functionality, outside of the realm of mere measurement.

Deploying this method, renders the system much more efficient and easier to configure than the prior hardware configurations. For example, one area wherein this functionality may be leveraged is the creation and control of a servo loop. The simplest and most generic example of a servo loop is a typical residential thermostat, wherein, depending on a particular reference (set point) of the room, when the temperature is detected to be at or below the set point, an electro mechanical action takes place which is used to signal a controller which will then turn the heat on for a certain period of time, until the temperature ascends to some level at or above the set point level, at which point the heat source turns off, then the cycle repeats when temperature falls again. Similarly as the present arrangement possesses control and measurement capability, the system can control many servo loops, by means of a plethora of stimuli and controls. The results of any of the above combinations of sensing and control can then trigger other useful functions with regard to system management or querying and reporting data. The signal conditioner modules 2,4 configure signals which come from sensors or transducers (whichever is appropriate for a particular measurement) which in turn connect to the A/D module(s) 1, 27 to be processed. It is largely the limits of these signal conditioners 2, 4 that diminish the quantity of the types of real world physics that are allowed to be processed by the A/D converter modules 1, 27. This invention establishes a framework that emphasizes additional configurability of the signal conditioners 2, 4 via USB to optimize the flexibility to process as many forms of real world physics as possible.

These programmable enhancements are made accessible to the user via the user GUI software which is responsible for a significant portion of system capability and configurability in both the external and internal measurement scenarios. This capability is also complemented through lower level software programming which is converted from USB into I2C and SPI protocols. Additionally A/D channels can be hardware configured to convert the system for use in infrared remote control applications, where essentially using these same USB A/D modules, in a totally different manner, provide a software accessible method to control certain system functions for control via infrared remote. This additional capability is added with very little additional hardware, which is another example of system is flexibility and configurability.

### Digital Input/Output (D I/O)

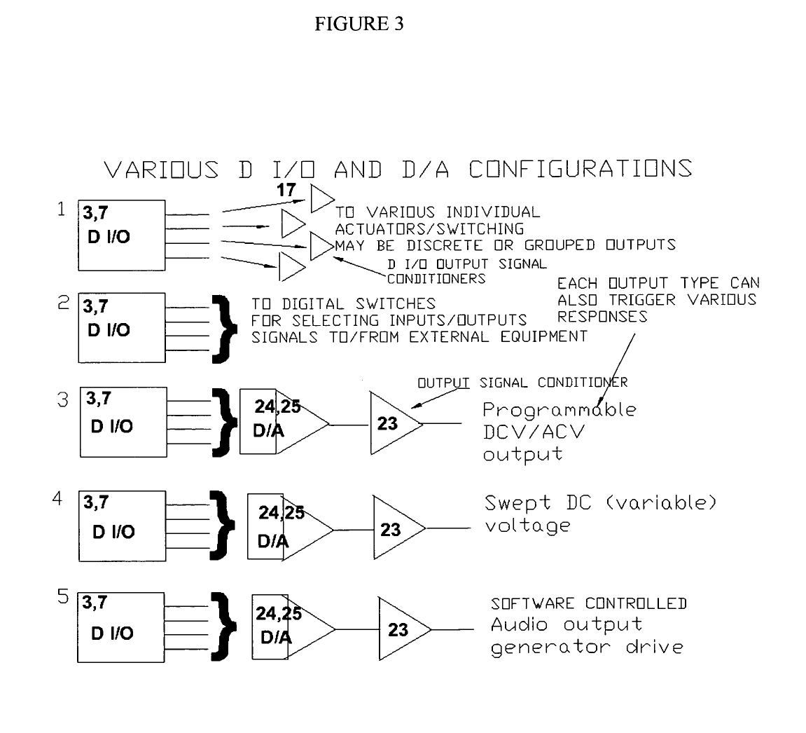

The D I/O modules 3, 7 illustrated particularly in FIGS. 1 and 3 are also responsible for a great portion of the value added functionality of the present system. The overall purpose of these modules is to facilitate a programmable method whereby any electrically controlled device can be manipulated through software. D I/O is useful to start and stop electrical devices via software control and this feature can be utilized to expand the efficiency of a test set up. For example, a test set up may include electronic switching for selecting different probe points of a test device or selecting the appropriate inputs or outputs to instrumentation. Within the present system, the user software configures the D I/O ports 14 and then maps the ports to predefined functions that need only be selected on a GUI control. This is one area where the advantages of USB can be clearly employed as previous technology required intrusive hardware changes to the computer in order to access and harness this type of low level control of computer signals. Often such a configuration was not practical, or was otherwise limited in useful external functionality, and incorporating this technology in the system architecture was prohibitive due to physical size limitations. However, with the advent of USB modules, the entire quantity of this power now becomes easily accessible and can be leveraged to accomplish a multitude of tasks.

Presently, a typical computer is merely processing banks upon banks of ones and zeros as a function of all of its tasks, the herein introduced D I/O modules 3, 7 harness this low level functionality and place it at our finger tips, predominantly via software controls. Employing this software, the user is provided with a programmatic method to control virtually any electrically actuated device. Ergo, this current system multiplies the usefulness of this capability by incorporating programmable hardware mechanisms, such as buffers or output signal conditioners 17, 18, comprising a design which overcomes any inherent shortcomings within applications and/or compatibility limitations. These buffers or output signal conditioners 17, 18, are capable of being configured to handle high or low power and voltage load requirements to provide maximum flexibility to this level of remote control. Similar to the A/D modules 1, 27 above, wherein much of the versatility is limited by the capabilities of the signal conditioner, the D I/O modules 3, 7 are limited by the power handling capabilities set forth by the output signal conditioners. The need for flexible internal output signal conditioning is minimal, but output signal conditioners for external use are conveniently configurable to handle essentially any real world application. Therefore, the present system again seeks to capitalize on the programmability of functions via the USB bus and has incorporated programmable buffers (signal conditioners) 17, 18, which are selectable based upon the power handling requirements of the particular application. Again the invention in essence enhances system capability through software, firmware and electrically programmable methods of adding functionality. There are clearly applications where raw D I/O ports 14 would have little value without the addition of circuit isolation or signal buffering. For example this system would be incompatible in high voltage applications if the buffered output conditioner 18, were not high voltage isolated. Therefore designated high voltage channels are created by incorporating isolated D I/O port channels 14 (isolation buffers not shown). Herein the outputs are distinguished by optocouplers and isolated solid state relays (forms of D I/O output signal conditioner, not shown). Similarly this system would be incapable of switching power in AC (Alternating Current) applications (via port 38) without thyristor isolated circuits. Thus certain internal D I/O channels herein are designated for this type of application set. For definition purposes, the thyristor is a solid-state semiconductor device with four layers of alternating N and P-type material. They act as bistable switches, conducting when their gate receives a current pulse, and continue to conduct for as long as they are forward biased (that is, as long as the voltage across the device has not reversed). Some sources define silicon controlled rectifiers and thyristors as synonymous. In this way also, the system exhibits configurability and is fully outfitted for another tier of applications, even while employing similar programmable modules.

Signals which can be individually controlled via USB, are typically in groups, accordingly this invention scatters multiple modules of 16 individual D I/O ports 14 for various functions, including DC switching, AC control and additional auxiliary purposes. One of the most important purposes of the D I/O modules herein is the provision of a method whereby any powered device may be turned on or off remotely or otherwise via software. The advantage is that any number of conditions can be configured to trigger such an event therefore it can be useful for providing security and peace of mind in regard to the actual power status of the overall system or even attached devices, in the event that human interaction isn't appropriate in the application. D I/O ports 14 can also be used to interactively or automatically via software to provide power and control to any number of devices on demand, This is conducive for remote exploratory test measurement and control scenarios.

In most configurations each port is configured separately to provide many individual channels of electrical control, but they take on a totally new set of added capability in the invention when used collectively. Some functions would include digital encoding, timing and counting functions to name a few. Another pertinent use for D I/O would include battery power management control, where in chosen modes of operation the D I/O could automatically switch out portions of the system that are not in use to reduce battery drain.

### Digital to Analog Conversion (D/A)

The Digital to Analog conversion (D/A) modules 24,25 as illustrated in FIGS. 1 and 3, is available to the user via the system front panel connectivity and configurable through user software. The D/A modules are a resource for numerous functions, one being a method to provide programmable stimulus for test configurations, as the D/A module can be employed to programmatically configure an adjustable voltage source, which could also be applied as stimuli in certain test set-ups. Applications for this configuration may include testing digital encoders.

Additionally, the D/A module can be used as a programmable power, waveform, audio, variable signal source and more for external use or internal/architectural applications such as system power management, wherein based upon certain conditions defined by software, battery power could be managed to conserve resources. This invention intends to include all possible uses for this type of D/A module whether described fully herein or not.

### USB to IEEE-488 Module

Presently, the most favored computer input output communications protocol used for instrumentation in automated applications has been and continues to be IEEE-488. This system was designed to optimize communications between multiple instruments located on the same bus. IEEE-488 possesses a robust command set designed to programmatically read and write the settings and input/output data, as well as the intricate set of instrument parameters for the settings and input/output data.

The implementation of this capability raises the level of compatible applications for the system significantly as the ability to connect, communicate and acquire data from industry leading instrumentation adds significant potential to the invention. This enables instruments to be programmatically configured via the user software and defined per the requirements of the particular application. Essentially all of the instrument settings and capabilities are configured over the IEEE-488-2 bus 10; in addition to all the other programmable attributes of the system. Sharing data acquisition between the internal A/D network and the IEEE-488 module 31 provides a method whereby the system can be quite useful in handling sophisticated data acquisition and control applications.

User software makes it possible to alter a test set up at anytime in the process to change instrument settings and parameters at will, interactively or sequentially. This form of control also is conducive to exploratory testing, due to the depth of control and power of the user software. If for example upon commencement of a testing process, the results appear to be unexpected or include spurious values, the system affords the user the opportunity to change a setting or parameter, in order to ascertain whether the change causes the desired effect, and therefore determine whether the existence of unexpected or inconsistent values is indeed due to inoperability the unit under test or the improper configuration of an instrument setting.

Herein, this depth of control is perfect for component and equipment characterization as this level of control clearly finds use in enhancing the efficiency of a test set-up and additionally in exploratory test and recording flexibility. Complimentary to these scenarios, the system provides the option to increase the number of instruments utilized to perform the same activity. The advantages of using IEEE-488 power to control instrumentation are evidenced as the system affords the user the ability to potentially arrange a combination of test scenarios, without the arduous and time wasting rotation of equipment and configuration for each scenario. Additionally, the user can employ his current equipment if desired and inherently avoid learning new instrumentation because IEEE-488 acts as a common computer communications protocol.

### USB to Serial Conversion Module

The USB to Serial conversion module 30 provides another example of the flexibility of the instant arrangement as USB to Serial conversion module 30 seeks to leverage the electrical and physical conveniences of USB to convert it to many useful communications conventions. This capability constitutes a useful addition to the platform as this expands the capacity of and applications for the system. The USB to Serial conversion module 30 may be employed to both augment the list of applicable devices from which to measure and diversify, but also to serve as a retro fit for test units that require previous technology to communicate with a computer. Certain instruments require serial communication, thus the USB to Serial conversion module 30 affords the opportunity to incorporate these devices to the list of applicable test, measurement and control scenarios. This module also provides a programmable method whereby the system may communicate with instruments and test subjects that are also not state of the art equipment. With this additional capacity, the present configuration encompasses all possible uses for serial communications, whether these uses are specifically described herein or not.

### The USB Hub Module

The utilization of the USB Hub module 29 constitutes utilization of an apparatus within the overall system wherein a network of modules, instruments and automated power may be interlinked and associated with only a single USB source. The Hub 29 is an effective method for expanding the system capabilities, with a minimum of physical interconnectivity to a computer. The Hub 29 represents an important lifeline for the system architecture in regard to linking an internal network of devices that can be electrically centralized, and yet be individually identified, accessed and controlled through software integration. The enumeration properties of USB create and foster a powerful and convenient working relationship with the integrated software. Additionally, USB contributes to the flexibility of the system to accommodate more applications, by simplifying the connectivity of additional modules and instrumentation on the system bus, while optimizing each link to software control. The latest technology has brought to market numerous types of USB instrumentation. Using a hub in the system allows other USB instruments to be readily connected and therefore enhances capability of the present system.

The System CPU with Ethernet Router and Storage Module

The system CPU with Ethernet Router and Storage module 32 (and its own software in the form of firmware) adds intriguing functionality and renders additional modes of operation. First, with integration of the system CPU with Ethernet Router and Storage module 32, connectivity to an external computer (with monitor) is no longer necessary as the user software may reside within the system CPU storage area and the CPU includes video monitor compatibility. Thus, the system CPU with Ethernet Router and Storage module 32 facilitates a truly stand alone operation mode. With this, the user can connect directly or remotely to the system to operate the user interface controls and displays, attached equipment and, if desired, recover the pertinent data at the conclusion of the test or measurement event.

The Ethernet router (included as part of 32) allows the system to be operated via IP over Ethernet and essentially converts any of the system components to the IP protocol, via user software control. The Ethernet router enables remote control over IP, which is quite useful for numerous purposes. Additionally Ethernet router provides a medium to publish the user interface on the web for remote access such as wired, wireless Wifi or wireless over USB cell modem.

As illustrated herein, the present system is quite capable in numerous of ways and the usefulness of the system greatly increases when you consider the value added by a remote access means. Essentially all of the controls and displays that are available in local mode may thus be accessed via remote means. With such access, the user may commence a test sequence to acquire data, query the system for any available test parameters, test and or acquire unit status, as well as query environmental data. In addition, the user may now interrupt the test sequence, alter a parameter or even commence use of a peripheral device mid stream. With the instant configuration, software Ethernet links may also be used to report warning conditions or catastrophic failure, by way of numerous indicator systems, one example of which may be via email notification.

With the advent of the instant design, test data may also be acquired and analyzed remotely, via the user interface, and the data file can be obtained when needed. In addition to clear advantages gleaned from Ethernet capability, the system will effectively report status or any other parameter which the software specifies. Thus in addition to possessing the functionality of a self monitored test lab, the instant system will also notify the user of any conditions specified by the software application. Many applications are listed herein, however the user is not limited to the suggested operations in any manner as the potential uses of Ethernet operation to link the advantages of each USB module 1^{st} will reap the well understood gains of equipment operation via internet control.

### Battery System

As outlined above, the favorably of diminished power requirements due to the design of the present system represents an additional advantage of USB technology over traditional mainframe systems. This advantage can be leveraged to render battery operation possible where no such configuration was achievable in the earlier technology. The introduction of battery operation is also conducive to the creation of a completely self contained and unattended system. A large degree of functionality can be accomplished while operating by the internal battery, and simultaneously internal system control can be employed for power management. For example when the system is only acquiring data (and not in control mode) the internal battery 8 power can be automatically and periodically selected to preserve internal battery consumption. As battery power is often only required in certain external control scenarios, battery power may therefore be automatically and periodically switched into service when in control mode. Indeed operation on internal battery 8 paves the way for a completely unattended and exploratory test lab wherein the user can operate and measure equipment entirely remotely if desired.

### Hardware Interface Ports

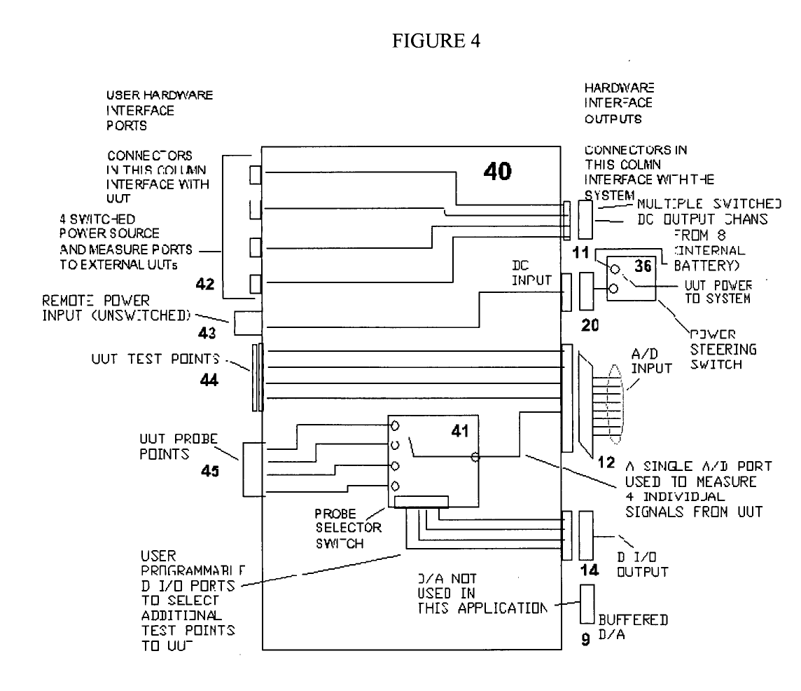

The Hardware Interface Ports, described hereinafter, are used for creating system interfaces with external units which are undergoing test, measurement or control. The Hardware Interface Ports (FIG. 4 items: 11, 20, 12, 14, 26, 9, 22, 10, 21, 37 and 38) are the inputs and outputs to the detachable Hardware Interface and as such, these ports are often preceded by the users own Hardware Interface; see FIG. 4. The individual user Hardware Interface 40 (AKA Detachable User Hardware Interface 40) includes all of the necessary connectivity for the particular units and necessary port conversion circuitry. For example, some users may want to connect to 8 different devices, each devices possessing connectors to interface to the system. Other users may be targeting a different quantity of devices, signal tailoring and also a different hardware connectivity scheme. The Detachable User Hardware Interface 40 possesses the capacity to embrace all of these connectivity demands. In addition, the Detachable User Hardware Interface 40 may also contain special circuitry that enhances the test, measurement or control processes. For example it may include programmatically controlled switches 41 that facilitate selection of a sequence of measurement probes or even multiple instrumentation ports.

In one embodiment, a detachable hardware interface port 42 provides switched power to 4 individual UUTs (Unit Under Test). Each port includes software enabled signals, voltage and current measurement capability for each UUT. Port 43 is the unswitched remote power input and includes enable, voltage and current measure. Port 44 provides the connectivity to the test points from the UUT to measure.

### DC Output Port

The DC Output Port 11 (FIG. 1) is the power distribution port for all external units under test. The DC Output Distribution and Control block 34 provides multiple channels of switched DC output for external units. Each switched DC output is driven by a programmable DC power supply that is enabled by independent D I/O 7 and output conditioning 18 signals, and then programmed over USB. In addition, the unit power for each channel is routed through A/D input (port 12) where the ability to programmatically measure both the source voltage and current at each individual channel of switched DC output is possible.

### DC Input Port

The DC Input port 20 constitutes the location wherein external DC power is applied to source external units via 15 and 34 and finally out port 11, where actual UUTs are connected via the detachable hardware interface, 40 in FIG. 4. The DC Input port 20 may also act as the source for external power to the system when not utilizing internal battery mode. For battery operation, an internal power steering switch programmatically selects between remote power and the internal battery source. In operation, the common of the power steering switch connects to the DC Power and Control for External Devices 15. In the remote power position, an external power supply is selected as the power source. An internal AC/DC power supply could easily be placed here if external DC power is not desired. The remote power is enabled by module 7 and measured by the system via internal A/D modules. Thus, when battery mode is selected, it can be programmatically set to bypass power to external units and fixed to provide internal power only, at which point external units may be powered via an external source at the DC input port 20 or an additional battery may be introduced if appropriate for the particular application.

### DC Power and Control for External Devices Block

The DC Power and Control for External Devices block 15 of the present system distributes power to external devices whether in battery mode or in external power mode. Power is routed from the DC input port 20 through block 15 and out to port 11 where power is distributed to the UUT(s) via the detachable interface hardware. It includes voltage and current measure via the system A/D 27.

### Internal DC Power and Control Block

The Internal DC Power and Control block 5 routes power to the CPU and other internal signal conditioning circuitry and further includes a path to the system A/D module to measure voltage and current. The Internal DC Power and Control block 5 also includes a power management circuit that possesses the capacity to control internal battery consumption programmatically. The main purpose of the power management circuit is to distribute power to the system architecture and control circuitry in either external power or internal battery mode. When placed in the remote power position, a battery conditioner circuit is engaged to keep the internal battery from draining. In addition, the Internal DC Power and Control block 5 is also the current source for the IR emitter 21, which can also be turned on or of via module 7.

### AC Power Control

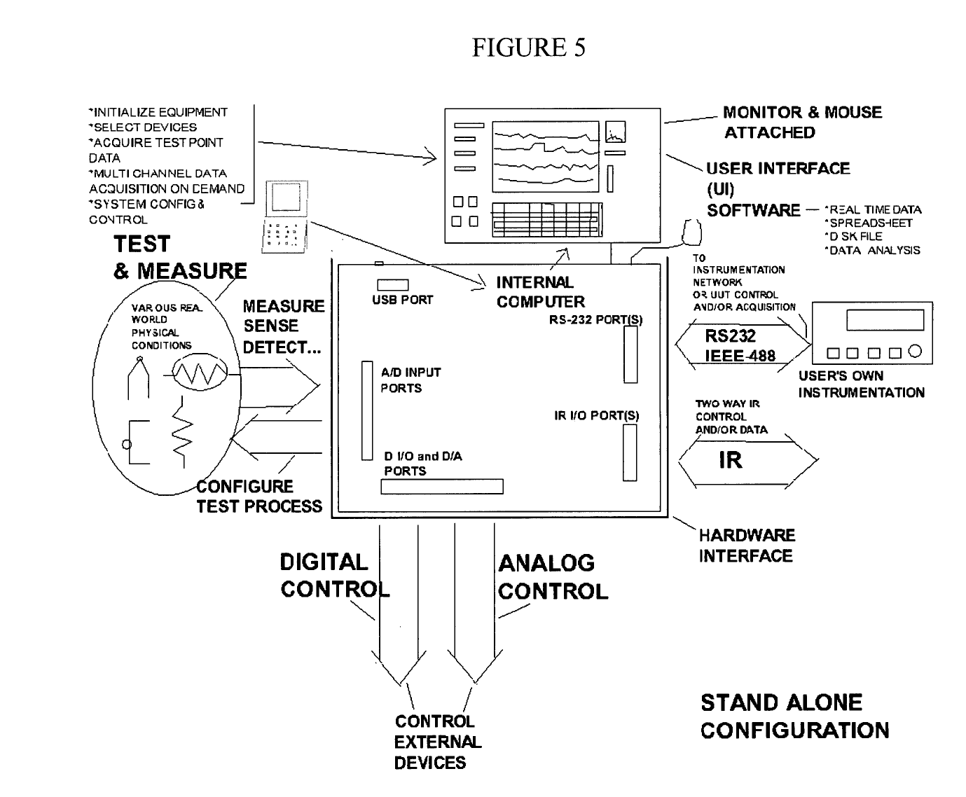

The AC Power Control block 6 manages external AC power from the AC input port 37 and provides switched AC output at port 38. The AC Power Control block 6 also provides an alternative to battery mode, namely the Non-stand Alone mode or Basic System Configuration, illustrated in FIG. 5, which allows the present system to be operated on typical home or business service power, 117 VAC, but it is mainly a port for an AC power source to be used for external AC switching and control. The AC Power Control block 6 also provides both switched and variable AC output to port 38. The switched output is controlled by internal D I/O from module 7 and variable output is sourced from port 25. The Internal circuitry located within AC Power Control block 6 allows complete control of AC power for external system use.

For example, in one embodiment, the necessity of disabling a large electrically actuated AC switch for powering machinery, upon detection of an extreme condition, may be accomplished by a single channel of A/D utilizing the instant invention. In the given scenario, the power cable to the machinery should be connected to the AC output on the system and the software would be partitioned to control the AC output 38, via the AC control hardware 6 of the system and D I/O 7 is enabled to respond to the selectable test conditions (displayed in the GUI software not shown) and thus shut down AC power when the limit is detected.

### Software and Control Elements

The system software represents a vital component of system effectiveness, reliability and ease of use. Additionally, the software is crucial to effective system configurability. The software consistently complements the system by enhancing functionality, configurability and power to the user with regard to all useful operator demands. It should therefore be an incentive to deploy a software design to the utmost degree to capture this type of user advantage and system capacity.

The above stated, it is the software that controls the performance of the system and this performance is organized in a hierarchy of software structuring that commences at the User Interface and descends into system control and configurability. The individual USB instrument modules which encompass the system management itself, as well as the appropriate attachable instruments and peripherals which are all included in this control sphere. This software defines not only the system and attachments that are managed and controlled, but additionally determines the degree of visibility of each device attribute to the user. This distinction is graded and often targeted in varying degrees, based upon the demands of the application presently in service.

Hence a software application is developed and utilized herein to target a particular level of performance, as well as to address the demands of the customer and effectively equip the operator to tap desired high level performance. The software application shall consist of an organization of software architectures, each intend to optimize all levels of functionality and performance. This perspective is made apparent at the upper level but defined in each and every level of the software design. With regard to the software, generally speaking, this system is designed to be flexible and configurable via the system hardware design, as well as the User Interface. In the broadest scope description, the software may comprise of three tiers as illustrated in the following functional description.

The upper level tier of the design represents the software level where the designer/developer sets the overall form and style. This tier (which comprises the software design itself) conveys the response to the requestor or “customer” demands concerning scope of performance and specific functionality. Hence the intended outcome should reflect all of the requirements presented in the form of software and incorporated within the Graphical User Interface tools. Included in this tier is control over the level and the selectability of user access to system hardware settings and parameters. This may include, but is not limited to, depth of system setting control and selectable devices and instruments.

For example depending on the demands of the individual user's access to setting and controlling parameters, each facet of the system's functionality may be limited to only those controls and features which are pertinent to the tasks that the requestor deems necessary. The user permission sequences may be guided by the degree of complexity associated with a particular application, some applications requiring more user setting flexibility, due to range of measurement types that may be of interest for example. In this particular application the user may be permitted access to a host of settings that a simpler application would not require. This level of user access is predefined by the software designer for the user based on the current demands (and any decided upon tradeoff or balance of said demands) received from the requestor and is applicable to the uppermost tier of software hierarchy.

Conversely, within the system, the user's access may intentionally be limited to one instrument, if so desired. This upper level tier of the software determines the type and depth of control available to the user. In parallel with this capability is the depth and level of user exposure to the system management and features, as related to configurability. Ease of use may also be predetermined based on expected skill level of the user and the results reflected therein. Additionally, various levels of control depth are settable and applicable to all tiers of the software application.

The User Interface design, also part of this tier, contributes powerfully to the quantity, diversity of control types, monitors, graphs, output file generation, visual user aids and any graphical enhancements defined to be user accessible by the software designer. It is imperative that this current system consists of the most effective Graphical User Interface (GUI) for accomplishing these conceptions. The GUI should be designed optimally to guarantee the most effective performance based on the demands of the requestor, and facilitate reduced user complexities. The user will thus possess the ability to tap all of the necessary functionality that is appropriate and plausible from the standpoint of the associated hardware.

The next tier of the software design consists of the software organization itself. This organization consists of small organizations composed of smaller functional blocks (which make up the lower tier) which become members of larger software modules. Similar to physical designs which possess various forms, these organized software modules come in different sizes and styles and are known as software architectures. These software architectures are typically responsible for providing sequence structure to task performance.

In addition to assisting in the optimization of performance, these architectures are essentially the governing infrastructure of all of the lower level functions and smaller functional software blocks. For example, for repetitious routines, the developer will tend to utilize one form of architecture, but for effective user interaction performance, another form of architecture may likely be chosen. Efficient architectures must be chosen for each appropriate task in order to procure the most effective system performance, and the chosen architecture must be tailored for effectiveness.

Finally, the lower tier includes all of the basic software functions. These are typically grouped in quantities and organized for specific micro tasks. These so called micro tasks are then organized to facilitate utility functions which are then structured to become a member of an organized design for performing greater tasks when linked with various sequencing structures. This lower level tier could be described as the domain where minimal functions become important when placed in a repetitive sequence. This also is important and effectiveness here is vital to system efficiency and overall performance, all of which must be implemented properly to accomplished the desired result.

The software utilized herein defines the degree of user control, the system management, the real time control and monitoring functionality, the data access, the local and remote data recording, the data reporting and the device control. The system modules are not necessarily proprietary, therefore the user may specify modules and request software in tandem for support of each.

Software architectures are created to address different advantages and concerns in the software design paradigm. A number of architectures are available to the software developer and they are to be designed and implemented into the system software structure to optimize all aspects of the system as they relate to the applicable particulars listed below:

Address, access and program internal as well as external devices via USB and to programmatically control, configure and query:

USB based modules of any type including DAQ and D I/O

GPIB devices

Serial devices

I2C devices

SPI devices

Facilitating System to system communications

User interaction

User interface tools and features

User selectable device control and selection

User interface monitoring

Interactive function and control

Programmatically access any attached instruments and peripheral devices:

Data processing and acquisition

Software flow control

Software timing

Data structure management

Sequence handling

Output data display methods

Graphing and table creation

Methods for data collection, storage and reporting

Parallel functionality

Repetitious activity

Command and control

System configurability

All forms of remote system control including but not limited to:

Ethernet via cell modem and satellite modem

### WiFi

### IP

### IR

### Telemetry

In summary, the most important features of the present system include the USB or Universal Serial Bus of which the system is based, is entirely different from mainframe buses. Designed to establish communications between devices that perform electrical tasks, it serves as a fast pathway for defining communications throughout the system, and also optimization of networking of a maximum number of devices providing essentially unlimited diversity of module types and therefore maximizing system versatility. The USB bus is designed for plug and play functionality therefore devices are readily added to the USB hub due to the enumeration properties that are inherent to USB. The system inherits these conveniences and they extend into how individual modules are accessed by software and how user and system software is executed in tandem.

The system also comprised of internal modules and is thus not limited to only USB bus devices. Other forms of computer communications may be handled by other communications configurations but are sourced via system USB pathway. The system will further comprise of a series or system of External Networking, designed for network and Ethernet not only for access to data but for complete control of the system, and due to the system's power essentially control any attached devices. Depending on the controllability of attached devices, the system may add or claim limited device control via software. Ethernet and wireless links will provide remote access to data and control of attached devices via the system.

Regarding system control, there may be a range of choices and communications protocols for controlling system and attached devices remotely. They are included but not limited to the following: Wireless RF, WiFi, Ethernet, IR, Bluetooth, Telemetry, Wired PC and any method for obtaining listed functions. Regarding data management, the system has ability to report essentially any parameter, setting or condition specified by software; in quantities.

Data reporting can be made available in many forms, local (on screen) remote via email, including—depending on range—infrared beam laser beam and any method conducive to software and compatible with chosen system modules, network infrastructure and any method that can be accomplished by infrastructure, defined by software and selectable by user system attachments (including attached devices), as well as internal parameters are accessible to user via software.

The system capabilities include internal as well as external measurement and control. The system power is managed internally as the system has multi way power functionality AC, DC internal or external means. Additionally, the system power, whether internal or external, can be controlled remotely and by software sequential and external connectivity not limited by system design but by customizable interface needs.

While there are shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

I claim:

1. An automation system for control, testing and measurement of system and device parameters:
a series of modules in electrical communication comprising:
an Analog to Digital (A/D) module;
a Digital Input/Output (D I/O) module comprising a plurality of the D I/O ports;
a Digital to Analog conversion (D/A) module;
a USB to IEEE-488 module;
a USB to Serial conversion module;
a USB Hub;
a system Central Processing Unit (CPU) with ethernet router and storage;
a battery system;
a plurality of hardware interface ports;
a plurality detachable hardware interface ports;
a DC Output Port;
a DC Input Port;
an AC power source;
an AC input port and an AC output port;
an external device DC power and control block;
an internal DC power and control block disposed to route power to the CPU and further disposed to route power to a series of internal signal conditioning circuitry, the internal DC power and control block and wherein the internal DC Power and Control block further comprises a path to the system A/D module to measure voltage and current;
an AC power control block unit disposed to manage the external AC power from the AC input port and provide switched AC output at the AC output port; and,
a user control software.

2. The automation system for control, testing and measurement of system and device parameters of claim 1 wherein an individual of the A/D modules is in communication with a computer mechanism wherein said computer mechanism fully control and processes the an individual of the A/D modules by way of software.

3. The automation system for control, testing and measurement of system and device parameters of claim 2 wherein the individual of the A/D modules in communication with and controlled and processed by the computer mechanism is configured to creation and control a servo loop.

4. The automation system for control, testing and measurement of system and device parameters of claim 1 wherein an individual of the A/D modules records internal measurements selected from the group consisting of dedicated system status monitoring and power management.

5. The automation system for control, testing and measurement of system and device parameters of claim 1 wherein software configures and maps the D I/O ports to predefined functions.

6. The automation system for control, testing and measurement of system and device parameters of claim 1 further comprising output signal conditioners.

7. The automation system for control, testing and measurement of system and device parameters of claim 6 wherein said output signal conditioners are configured to handle high or low power and voltage load requirements.

8. The automation system for control, testing and measurement of system and device parameters of claim 1 wherein the D/A module provides programmable stimulus for testing digital encoders.

9. The automation system for control, testing and measurement of system and device parameters of claim 1 wherein the D/A module comprises a programmable power source and is utilized as a system power management.

10. The automation system for control, testing and measurement of system and device parameters of claim 1 wherein the internal DC Power and Control block further comprises a power management circuit disposed to control internal battery consumption programmatically.

11. The automation system for control, testing and measurement of system and device parameters of claim 1 further comprising a battery conditioner circuit disposed to prevent an internal battery from draining and wherein the automation system for control, testing and measurement of system and device parameters is in a remote power position.

12. The automation system for control, testing and measurement of systems and devices parameters of claim 1 wherein the AC power control block unit comprises a non-stand alone mode which allows the automation system for control, testing and measurement of systems and devices parameters to be operated on typical house power 117 VAC.

13. The automation system for control, testing and measurement of systems and devices parameters of claim 13 wherein a switched output is controlled by internal D I/O module and variable output is sourced from a port.

14. The automation system for control, testing and measurement of systems and devices parameters of claim 13 wherein an A/C power and control module comprises internal circuitry for control of AC power for external system use.

15. The automation system for control, testing and measurement of system and device parameters of claim 1 wherein the system is configured to disable an electrically actuated AC switch for powering a machinery upon detection of an extreme condition and wherein a power cable in communication with the machinery is connected to the AC output of the automation system and the software is partitioned to control the AC output via the AC control hardware of the system and wherein the D I/O is enabled to respond to a set of selectable test conditions and shut down AC power when the limit is detected by utilizing a single channel of A/D of the automation system for control, testing and measurement of system and device parameters.

16. The automation system for control, testing and measurement of systems and devices parameters of claim 1 further comprising a power management circuit disposed to distribute power to the system module and control circuitry in either external power or internal battery mode.

17. The automation system for control, testing and measurement of systems and devices parameters of claim 1 wherein input stimulus is derived from the D/A output power supplied to a test unit via the switched DC output port and the buffered D/A output port is connected to the input of the test unit which is providing a stimulus in order to measure a test unit's output frequency across an array of temperatures to determine where the performance limits are characterized.

18. The automation system for control, testing and measurement of systems and devices parameters of claim 1 wherein the system is network and Ethernet elements access data, control the system, and control attached devices.

19. A testing and measurement system comprising:
a Universal Serial Bus component disposed to establish communications between devices for plug and play operation with a PC, to serve as a fast pathway for defining communications throughout the system and to optimize networking of a maximum number of devices providing essentially unlimited diversity of module types and therefore maximizing system versatility;
a series of internal modules;
an external network system; and,
a data management system.
